(19) United States
(12) Patent Application Publication
(10) Pub. No.: US 2025/0046296 A1
(43) Pub. Date: Feb. 6, 2025

(54) AUTOMATED PREDICTION OF PRONUNCIATION OF TEXT ENTITIES BASED ON PRIOR PREDICTION AND CORRECTION

(71) Applicant: GOOGLE LLC, Mountain View, CA (US)

(72) Inventors: Leonid VELIKOVICH, New York, NY (US); Ágoston WEISZ, Pfaeffikon (CH)

(73) Assignee: GOOGLE LLC, Mountain View, CA (US)

(21) Appl. No.: 18/362,457

(22) Filed: Jul. 31, 2023

(51) Int. Cl. G10L 13/08; G06F 40/126

(52) U.S. Cl. CPC G10L 13/08; G06F 40/126

(57) ABSTRACT

A method, device, and computer-readable storage medium for predicting pronunciation of a text sample. The method includes selecting a predicted text sample corresponding to an audio sample, receiving a correction text sample corresponding to the audio sample, updating an encoding of allowable pronunciations of the correction text sample based on the predicted text sample and the audio sample, the updated encoding of allowable pronunciations of the correction text sample including a pronunciation of the predicted text sample, and predicting a pronunciation of the correction text sample based on the updated encoding of allowable pronunciations of the correction text sample.

### BACKGROUND

### Field of the Disclosure

The present disclosure relates to encoding and predicting pronunciations of text entities.

### Description of the Related Art

Automatic Speech Recognition (ASR) is a field of technology enabling electronic devices and systems to process an inputted audio sample or signal, the audio sample including spoken language. ASR can include, for example, a determination of a text representation of spoken language. The text representation can then be processed for meaning using natural language processing (NLP) systems.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is related to a method for predicting pronunciation of a text sample, comprising selecting, via processing circuitry, a predicted text sample corresponding to an audio sample; receiving, via the processing circuitry, a correction text sample corresponding to the audio sample; updating, via the processing circuitry, an encoding of allowable pronunciations of the correction text sample based on the predicted text sample and the audio sample, the updated encoding of allowable pronunciations of the correction text sample including a pronunciation of the predicted text sample; and predicting, via the processing circuitry, a pronunciation of the correction text sample based on the updated encoding of allowable pronunciations of the correction text sample.

In one embodiment, the present disclosure is related to a device comprising: processing circuitry configured to select a predicted text sample corresponding to an audio sample, receive a correction text sample corresponding to the audio sample and based on the predicted text sample, update an encoding of allowable pronunciations of the correction text sample based on the predicted text sample and the audio sample, the updated encoding of allowable pronunciations of the correction text sample including a pronunciation of the predicted text sample, and predict a pronunciation of the correction text sample based on the updated encoding of allowable pronunciations of the correction text sample.

In one embodiment, the present disclosure is related to a non-transitory computer-readable storage medium for storing computer-readable instructions that, when executed by a computer, cause the computer to perform a method, the method comprising: selecting a predicted text sample corresponding to an audio sample, receiving a correction text sample corresponding to the audio sample and based on the predicted text sample, updating an encoding of allowable pronunciations of the correction text sample based on the predicted text sample and the audio sample, the updated encoding of allowable pronunciations of the correction text sample including a pronunciation of the predicted text sample, and predicting a pronunciation of the correction text sample based on the updated encoding of allowable pronunciations of the correction text sample.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a method for generating a predicted pronunciation of a text entity, according to an exemplary embodiment of the present disclosure;

FIG. 2 is a schematic of a user device for performing a method, according to an exemplary embodiment of the present disclosure;

FIG. 3 is a schematic of a hardware system for performing a method, according to an exemplary embodiment of the present disclosure; and

FIG. 4 is a schematic of a hardware configuration of a device for performing a method, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Mapping a text entity to a predicted pronunciation can enable an electronic device to accurately recognize and match a spoken text entity using ASR. The text entity can be any grouping of letters, including a grapheme, a syllable, a word, a name, or a phrase. In order to convert speech to text, a device can first determine a mapping of a word, phrase, or name to a pronunciation. The pronunciation can include a phonetic representation. In one embodiment, the mapping of the text entity to a pronunciation, as used herein, can include mapping the text entity to a neural embedding, wherein the neural embedding can be used for ASR and/or pronunciation prediction. For example, the neural embedding of a text entity can be an intermediate form that can be used by, or encoded in, an ASR model (e.g., an end-to-end speech recognition model) in addition to or in place of the original text entity. In one example, the intermediate form can be used in a language learning model (LLM) for speech recognition, such as through hypothesis spelling correction and rewriting.

The determination of the pronunciation can enable the device to convert an incoming audio sample into a text transcription in a speech-to-text conversion. In instances where a pronunciation of a text entity is unknown, a device can predict the pronunciation based on prior pronunciation data, context, and phonetic rules. However, an initial prediction may not be accurate, especially when the text entity is a proper noun, is in a different language than a typical language used by the device, or is not a known word or name. There is a large amount of variability in human speech, and ASR systems often have to update and correct pronunciation predictions in order to accurately process an audio input. In one embodiment, the present disclosure provides systems and methods for receiving a correction input for a pronunciation and updating a pronunciation prediction system based on the correction input.

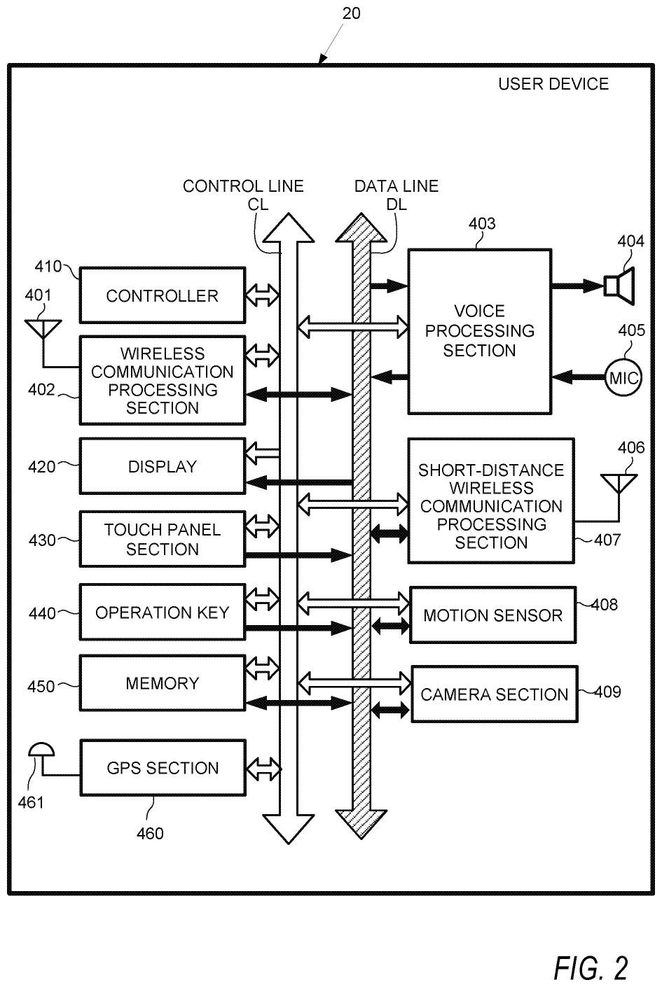

In one embodiment, a device can use ASR to process a speech request in an audio sample. The speech request can include, for example, a command or a question that is spoken by a human or a non-human system. The device can be an electronic device including, but not limited to, a mobile device (phone), a computer or tablet, or a wearable device. In one embodiment, the electronic device can be a consumer device, such as a television, a vehicle, or an appliance such as a smart speaker or screen that can be configured for audio (voice)-activated functions. In one embodiment, the device as referred to herein can be a networked electronic device, such as a computer or a server, that can perform ASR functions for client devices (second devices). A client device can be an electronic device that records or receives an inputted audio sample, such as a mobile device, a wearable device, a consumer device, an appliance, etc. The client device can transmit the audio sample to the networked device over a network connection, and the networked device can process the audio sample using the ASR techniques described in the present disclosure. The networked device can transmit an output to the client device in response to the audio sample. The output can include a transcription of the audio sample or a data intermediate that can be used to process and respond to the audio sample. Examples of the electronic devices, including networked devices, and client devices, can include the hardware devices described herein with reference to FIG. 2 through FIG. 4 or any of the components thereof.

In one embodiment, a device can be configured for ASR in a manner that is customized to a user of the device. For example, the device can be a personal mobile device that is regularly and exclusively used by a single user. The user of the device can have unique modes of speech and/or qualities of speech. The device can use prior speech input from the user to update ASR functions in order to process new speech from the user. The speech recognition and pronunciation prediction of the device can conform specifically to the speech of the user for improved accuracy. In one embodiment, a device can be used by more than one user. In one embodiment, a user can be associated with a user profile, wherein the device can store or access the user profile in order to process an inputted audio sample. In one embodiment, the device can select a user profile based on the audio sample. For example, the device can perform voice recognition to identify a user and select a corresponding user profile. In one embodiment, the device can receive an input, such as a selection of a user profile, indicating a user of the device. The device can process the audio sample based on the selected user profile.

A single text entity can correspond to one or more allowable and plausible pronunciations. In addition, factors such as audio quality, speed of speech, and speech context (e.g., the spoken words surrounding the text entity) can affect the pronunciation of a text entity in an audio sample. It can therefore be necessary for a device to generate a pronunciation model for a text entity, wherein the pronunciation model can include a number of pronunciations for a single text entity. The pronunciations can include pronunciations derived from speech samples that were previously recorded and predicted pronunciations. The pronunciation model can include a mapping or encoding of the text entity to one or more pronunciations. A pronunciation associated with a text entity can be referred to herein as an allowable pronunciation. The allowable pronunciations in the pronunciation model can include both likely and unlikely pronunciations, and the encoding of each pronunciation can indicate a predicted accuracy or likelihood of the pronunciation being correct. In one embodiment, the encoding of a pronunciation can include a measure of similarity between a first pronunciation and a second pronunciation. For example, the first pronunciation can be a likely pronunciation and the second pronunciation can be an unlikely pronunciation.

The pronunciations in the pronunciation model can include pronunciations of the text entity as well as pronunciations of other (reference) text entities, which can be referred to herein as reference pronunciations. The reference text entities can be similar to the text entity of the pronunciation model. For example, the reference text entities can share letters, syllables, or graphemes in common with the text entity. In one embodiment, the reference pronunciations can be similar to the predicted pronunciations of the text entity. For example, the pronunciations can share syllables or phonemes. The reference pronunciations can be unlikely pronunciations of the text entity but can be included in the phoneme space to indicate the limits of allowable pronunciations. In one embodiment, the reference pronunciations can be pronunciations that can correspond to more than one text entity. For example, a reference pronunciation can be a pronunciation of a homophone with the text entity. In one embodiment, the pronunciation model can include a predictive model configured to generate possible pronunciations of the text entity. The device can determine whether an inputted sound matches a pronunciation in the pronunciation model of a text entity for speech recognition.

In one embodiment, the allowable pronunciations in the pronunciation model can be arranged in a list, cache, or similar data structure. In one embodiment, the pronunciations in a pronunciation model for a text entity can be encoded in a phoneme space, wherein a position of pronunciations in the phoneme space can correspond to a confidence or a predicted accuracy of each pronunciation for a given text entity. The phoneme space can be an example of an encoding of the allowable pronunciations in the pronunciation model. In one example, the confidence can be based on a phonetic fit or an acoustic score of the pronunciation. The phoneme space can be modeled in two dimensions or can have more than two dimensions. In one embodiment, the boundary of the phoneme space can form a convex hull enclosing a locus of likely pronunciations associated with the text entity. In one embodiment, the boundary of the phoneme space can be formed by pronunciations, such as the reference pronunciations, that are known to be unlikely pronunciations but that are similar to the predicted pronunciations according to a metric of similarity or accuracy. The metric of similarity can include, for example, a proximity in a grapheme or phoneme mapping space. In one embodiment, the metric of similarity can be determined by an embedding of graphemes or phonemes. The embedding can be, for example, a neural embedding of graphemes or phonemes. Thus, pronunciations that deviate from the correct pronunciations can be excluded from the enclosed space of likely pronunciations. The inclusion of the similar reference pronunciations in the phoneme space can impose limitations on possible pronunciations of the text entity and can enable the device to distinguish between correct and incorrect, or likely and unlikely, pronunciations. For example, a pronunciation that is very similar to the reference pronunciation may be unlikely, as it is more likely to correspond to the reference text entity.

In one embodiment, the device can generate and update a pronunciation model for a text entity based on prior audio samples that have been received and used in speech recognition tasks. For example, a device can generate a pronunciation model for a text entity and can update the pronunciation model to include a pronunciation from an audio sample when the text entity is identified in the audio sample. Pronunciation of the same text entity can vary among different audio samples. In addition, the certainty of speech recognition can vary for each audio sample. Each audio sample can provide additional pronunciation data that can be used to refine the phoneme space of the text entity. In one embodiment, the device can encode an audio sample as a pronunciation of a text entity. The audio samples can be stored (e.g., cached) locally or remotely. The device can then use the prior audio samples (encoded pronunciations) corresponding to a text entity to generate and update a pronunciation model for the text entity. As the device receives more audio samples, the device can also modify prior encoded pronunciations based on new pronunciation data. The prior audio samples can include audio samples wherein the text entity has been positively identified with a high certainty, as well as audio samples wherein the text entity is identified with a low certainty.

In one embodiment, the device can generate a posterior distribution of pronunciations of a text entity. The posterior distribution can include the likelihood of one or more pronunciations of the text entity based on prior audio samples. The device can update the posterior distribution as new pronunciation data (e.g., audio samples) are received. The device can use the posterior distribution to compute a posterior likelihood of a given pronunciation for a given user. In one embodiment, the device can determine a most likely pronunciation based on the posterior distribution. For example, the device can use maximum likelihood estimation (MLE) or maximum a posteriori estimation (MAP) over possible pronunciations of a text entity to determine a most likely pronunciation with respect to the pronunciations of prior audio samples. The most likely pronunciation can be a pronunciation from a prior audio sample or can be a new pronunciation that is generated by a prediction model. The device can test and refine the pronunciation model using the prior audio samples.

In one embodiment, the device can use a prediction model to generate or predict pronunciations to populate the phoneme space based on the pronunciation model. In one embodiment, the prediction model can be a machine learning model and can include sequence-to-sequence model architecture, such as a recurring neural network (RNN) and/or a long short-term memory (LSTM) architecture, to transform a text sequence to a speech sequence. In one embodiment, the prediction model can include a grapheme-to-phoneme (G2P) model to predict a pronunciation of a text entity. The G2P model can use phonetic rules and/or a phonetic dictionary to predict the pronunciation of the text entity. In one embodiment, the G2P model can use one or more phoneme spaces to predict a pronunciation of a text entity. For example, the device can input one or more reference pronunciations for different text entities that are similar to but not acceptable as potential pronunciations for the text entity to the G2P model. The reference pronunciations can be, for example, incorrect pronunciations that were previously proposed by the device and corrected. In one embodiment, the reference pronunciations can be selected based on at least one metric of similarity. The metric of similarity can be a similarity between the text entities or between the pronunciations. The G2P model can use the reference pronunciations as limitations when predicting a pronunciation of the text entity. For example, a predicted pronunciation can differ from a reference pronunciation in one or more phonemes so as not to be identical to a reference pronunciation. In one embodiment, the device can arrange the pronunciations in the phoneme space based on the reference pronunciations that were input to the G2P model. For example, the proximity between a predicted pronunciation and a reference pronunciation in the phoneme space can depend on whether the reference pronunciation was used in the prediction by the G2P model.

In one embodiment, the predictive model can use zero-shot learning methods to predict the pronunciation of the text entity. Zero-shot learning can refer to a model (e.g., a G2P model) predicting a pronunciation for a text entity (e.g., a grapheme, previously unseen word) that was not explicitly observed in training of the model. In one embodiment, a predictive model can use auxiliary information, such as phonetic rules for a certain language, to predict a pronunciation for a text entity. For example, the device can input the text entity to a G2P model. The G2P model can determine that the text entity is a common name in a language based on information such as the spelling of the name. The G2P model can then predict a pronunciation of the name according to the language of the name. The device can use the G2P model to predict one or more pronunciations and can add the output pronunciations to the phoneme space. In one embodiment, the G2P model can output a confidence corresponding to a predicted pronunciation. The device can arrange the predicted pronunciation in the phoneme space based on the confidence.

In one embodiment, the device can update the encoding of the pronunciation model for a text entity based on prior audio samples corresponding to the text entity. For example, the device can assign a rank or score to allowable pronunciations for a text entity, wherein the allowable pronunciations are based on prior audio samples corresponding to the text entity. The device can modify the encoding of the pronunciation model of the text entity based on prior audio samples, e.g., by updating a confidence or likelihood of a pronunciation based on a similarity to pronunciations in prior audio samples. In one embodiment, the device can train or retrain a pronunciation prediction model using the prior audio samples. In one embodiment, the device can run (or rerun) an ASR process, such as decoding an audio sample to determine a text entity corresponding to the audio sample, based on received audio samples. In one example, the device can constrain an ASR decoder to predict a limited set of text entities. The re-decoding of the prior audio samples can include recalculating a likelihood or certainty for each pronunciation. In one example, the device can determine a speech-text alignment by implementing a time constraint on decoded transcripts, the time constraint being based on prior audio samples. The emitted transcript should fit within the time boundaries of the audio sample. In one embodiment, the device can train an ASR recognizer to emit phoneme sequences corresponding to an audio sample. The phoneme sequences can be emitted to in place of or in combination with words. In one embodiment, the device can train an ASR recognizer to emit phoneme sequences corresponding to a prior audio sample, wherein the prior audio sample has been encoded as a pronunciation of a text entity of interest. The generation of phoneme sequences can be used to identify phonemes corresponding to the text entity. The device can then use the phonemes of the phoneme sequence to predict a new pronunciation of the text entity. The new pronunciation can be based on one or more phonemes of the phoneme sequence and can be determined independently of pronunciations of other text entities (e.g., reference pronunciations). The device can thus generate new pronunciations without relying on existing pronunciations associated with the text entity or any pronunciations of existing words. In one embodiment, the device can use the ASR recognizer on more than one audio sample in order to minimize variation/noise between audio samples, as a phoneme sequence can be more variable than known word sequences.

In one embodiment, the device can use surrounding context of an audio sample to select a predicted text entity corresponding to the audio sample. For example, a speech request can include a command to initiate communication with a contact stored in the device's digital address book. The device can identify command words related to initiating communication, such as to “call” or “send a message.” The device can then determine that there is an increased probability that subsequent or surrounding words in the speech request can correspond to pronunciation of a name of a contact stored in the device's digital address book. The device can use pronunciation models corresponding to contact's names to select the contact named in the speech request. In one example, a speech request can include a command to initiate navigation to a location. The device can identify command words relating to navigation, such as to “map” or “start a route” to a location. The device can then determine that there is an increased probability that subsequent or surrounding words in the speech request can correspond to pronunciation of a location. The location can be, for example, a named geographical location or an address associated with a contact in the device's digital address book. The device can use pronunciation models corresponding to geographical locations to select a location as a text entity.

Storing and using prior audio samples to update a pronunciation model can improve the likelihood of correctly predicting a pronunciation because the audio samples can include pronunciations in varying contexts. As an example, an audio sample can include a pronunciation of a text entity that is decoded with high certainty. The high certainty can be due to the decoded text entity being positively confirmed via an input to the device. In one embodiment, the high certainty can be based on the context of the audio sample. For example, the device can use the context of the audio sample to constrain the types of text entity (e.g., contact names) that are predicted based on the audio sample. The high-certainty pronunciation can be used to analyze new audio samples that may lack context or confirmation. When receiving a subsequent audio sample, the device can decode the audio sample to predict a text entity by comparing an acoustic score of the new audio sample with an acoustic score of a prior audio sample that was decoded with high certainty. For example, if the pronunciation in the subsequent audio sample matches the pronunciation of the prior audio sample, the device can assign a high acoustic score to the pronunciation in the subsequent audio sample regardless of the context of the audio sample. The device can also use pronunciations from prior audio samples with low certainty to update a pronunciation model and/or as a reference pronunciation for assessing a new audio sample.

In one embodiment, the device can generate and update the pronunciation model for a text entity based on prior audio samples as a retrospective process. The device can update pronunciation models at any point after an audio sample is received or recorded. For example, the device can receive and process an audio sample and can update the pronunciation model for a text entity corresponding to the audio sample at a later time. In one embodiment, the device can update a pronunciation model in a background thread and/or while performing other tasks. The device can update the pronunciation model locally or can transmit the prior audio samples to a networked device for processing. The networked device can receive audio samples from one or more client devices corresponding to one or more users and can update a pronunciation model for a text entity based on the audio samples from the one or more client devices. The device can then use an updated pronunciation model and aggregate knowledge of prior audio samples to improve accuracy of pronunciation predictions for a text entity.

In one embodiment, the device can generate and update the pronunciation model for a text entity based on prior pronunciation predictions, even when the prior predictions are incorrect. A device can respond to a speech request by outputting synthesized speech, displaying content, and/or executing processes based on the speech request. In one embodiment, the device can generate a prompt, e.g., as an audio or a display output, in order to confirm the speech request. For example, the device can receive a speech request to call a contact stored in the device's digital address book. The device can process (e.g., decode) the speech request to identify the contact named in the speech request and can display a confirmation prompt to confirm that the device accurately identified the contact. The confirmation prompt can include a text entity, such as the name of the contact, that was identified by the device from the speech request using ASR. The device can receive an input, such as an audio input or an input via a user interface (UI) of the device, in response to the confirmation prompt. When the name is correct, the device can update the pronunciation model for the name based on the confirmation response to increase the probability of correctness of the pronunciation from the speech request or strengthen the encoding of the pronunciation from the speech request.

In one embodiment, the input can be a correction input when the name is incorrect. As an example, the device can record or receive an audio sample including a speech request to call a first contact. The device can incorrectly process the speech request and predict that the speech request included the name of a second contact rather than the name of the first contact based on the pronunciation of the name in the speech request. The device can then display the name of the second contact rather than the name of the first contact in the confirmation prompt. A correction can be input into the device indicating that the speech request included the first contact's name rather than the second contact's name. The correction input can be, for example, a text input with the first contact's name. In one embodiment, the device can display the name of the second contact as well as one or more alternative contact's names that have similar pronunciations. The alternative contacts can be selected based on an overlap or proximity of phoneme spaces for the alternative contact names and the predicted contact name. The correction input can include a selection of one of the alternative names. The device can then generate and/or update the pronunciation model for the inputted name (e.g., the contact's name in the text input or the selected alternative name) based on the correction input.

In one embodiment, the confirmation prompt and the correction input can include audio samples. For example, the device can synthesize speech as a confirmation prompt. As an example, the synthesized speech can include the name of the second contact, which is incorrect. The device can record or receive a correction input in the form of a second audio sample in response to the confirmation prompt. The second audio sample can include, for example, the user repeating the name of the first contact. The device can update the pronunciation model for the first contact's name to include the pronunciation in the second audio sample. The correction input can indicate that the second contact was incorrect and can reinforce the pronunciation of the first contact.

In one embodiment, the device can perform an action based on the speech request. For example, if the speech request includes a command to call a contact, the device can initiate the call to a contact whose name was identified using ASR. The correction input received by the device, as used herein, can include an action (input) or a lack of action (input) related to a confirmation prompt or an action taken by the device. For example, when a device initiates a call to the wrong contact, a user can end the call rather than allowing the call to continue. The action of ending the call can be a correction input that can be received by the device via a user interface and can be used to update a pronunciation model. For instance, the action of ending the call can indicate that the contact's name, as determined by the device, was incorrect. The device can update the pronunciation model of the contact's name based on the correction input, as will be described in further detail herein. In one embodiment, the device can receive and use more than one correction input to update the pronunciation model. For example, after receiving an instruction to end a first call to an incorrect contact, the device can receive a second input (instruction) to initiate a second call to the desired (correct) contact. The input can be another speech request or can be input via the user interface of the device. For example, an input to a dial pad of the device can be used to initiate the second call to the correct contact. The device can identify the correct contact as being different from the incorrect contact that was initially predicted. The ending of the first call and the initiation of the second call can be correction inputs to the device. The device can analyze the sequence of actions and can determine that the contact of the second call is the correct contact corresponding to the initial speech request. The device can then update pronunciation encodings for one or more contact names based on the sequence of actions.

In one example, the device can record or receive an initial speech request to play a song, wherein the speech request includes the title of the song. The device can process the speech request using ASR and can begin playing a song identified in the speech request. When the device incorrectly identifies the song (plays the wrong song), the device can receive an input indicating that the song is incorrect. For example, the device can receive an instruction to stop playing the current song or to play a different song. The instruction (input) or action following the speech request can be a correction input to the device that indicates whether the device correctly identified the phonemes in the initial speech request. In one example, the correction input can be a second speech request, wherein a user repeats the song named in the initial speech request at a different or the same volume, speed, enunciation, etc. The device can process the second speech request using ASR and can identify a song title in the second speech request. The song title can be a different title than the initially predicted song.

In one embodiment, a correction input to a device can include an initiation of a process. In one embodiment, the correction input can include a termination of a process, such as an instruction to close an application or a window. In one embodiment, a correction input to a device can include an instruction to reverse or undo a previous action, or to execute an opposing action to the previous action. For example, an appliance such as a smart speaker can record or receive a speech request and can process the speech request using ASR. The smart speaker can identify that the speech request includes an instruction to turn on the lights in a room and can execute the action of turning on the lights. In the case where the smart speaker incorrectly processes the speech request, the smart speaker can receive a second speech request to turn off the lights that had previously been turned on. The second speech request, which includes an instruction to undo a previous action, can be an indication that the previous action was executed based on an incorrect processing of the first speech request. The device can use the correction input (the second speech request including the instruction to undo the previous action) to update pronunciation models for one or more text entities associated with the initial speech request and/or the correction input.

In one embodiment, a lack of input (action) can also be used by the device to update a pronunciation model. For example, when the device correctly predicts a text entity and performs an action corresponding to the predicted text entity, a user may not have any reason to interrupt or undo the action. Therefore, the complete execution of the action by the device can be an indicator that the text entity was correctly predicted. The device can update one or more pronunciation models, e.g., the pronunciation model for the correctly predicted text entity, based on the lack of input. In one embodiment, a subsequent input (action) to the device can also indicate that the text entity was correctly predicted. For example, the device can receive a speech request to display directions to a location. The device can process the speech request using ASR to identify the name of the location and can display directions to the identified location. When the identified location is correct, the device can receive an input (e.g., a second speech request or an input via a UI of the device) to start a route to the identified location. The subsequent input can be a confirmation that the device correctly identified the location in the speech request. The device can then update the pronunciation model for one or more text entities (e.g., the identified location name) based on the subsequent input.

According to one embodiment of the present disclosure, the device can update the pronunciation model for the correct text entity (e.g., a contact's name) based on both the correction input and the incorrect prediction. The correction input can indicate the correct text entity corresponding to the received audio sample. For example, the text entity can be the name of the first contact, which is stored or accessed by the device. The device can include the pronunciation from the audio sample in the pronunciation model for the name of the first contact or can update a probability of correctness associated with the pronunciation from the audio sample. In one embodiment, the pronunciation from the audio sample can be encoded within a phoneme space containing likely pronunciations. The device can further use the correction input to determine a relationship between the incorrect prediction and the correct text entity. In one example, the relationship can include a distance between the pronunciation of the incorrect prediction and the pronunciation of the correct text entity. The distance can be based on an acoustic score or a phonetic dictionary. For example, the device can determine based on the correction input that the pronunciation of the text entity is similar to, but not interchangeable with, the pronunciation of the incorrect prediction. The device can further determine a level of similarity or points of similarity and differentiation between the pronunciations.

In one embodiment, the device can include the pronunciation of the incorrect prediction in the pronunciation model of the text entity. In one embodiment, the device can generate possible pronunciations of the text entity based on a similarity to the pronunciation of the incorrect prediction. For example, the device can modify one or more syllables of the pronunciation of the incorrect prediction to generate possible pronunciations of the text entity. The possible pronunciations can be generated by and/or stored in the pronunciation model. In one embodiment, the pronunciation of the incorrect prediction can be added as a reference pronunciation to the pronunciation model of the text entity. The reference pronunciation can be used as a boundary point for enclosing possible or likely pronunciations of the text entity, as has been described herein. The enclosed phoneme space of pronunciations can also be updated to include pronunciations that are similar to the reference pronunciation. In one embodiment, the inclusion of the reference pronunciation can also be used to exclude possible pronunciations from the phoneme space. For example, a pronunciation that differs from a correct pronunciation more than the reference pronunciation does can fall outside of the boundary formed by the reference pronunciation. Notably, the device can generate and update the pronunciation model without requiring proactive data entry by a user, such as the user inputting a speech sample including a new contact's name when creating the new contact.

In a similar manner, the device can update a pronunciation model for the incorrect text entity based on the received correction input. For example, the incorrect text entity can be associated with a phoneme space of possible pronunciations. The correction input received by the device can indicate that there is a similarity between the pronunciation of the text entity in the audio sample and the pronunciation of the incorrect prediction. In one embodiment, the pronunciation of the correct text entity can be added as a reference pronunciation for the incorrect text entity. In one embodiment, the pronunciation of the correct text entity can be used to generate predicted pronunciations for the incorrect text entity. In this manner, the device can update more than one pronunciation model based on a single instance of speech recognition. The correction input can result in both pronunciation models becoming more accurate.

The approach of generating and updating a pronunciation model for a text entity based on correction inputs can provide a more flexible and accurate system for speech recognition. Notably, a device as described herein can generate new predicted pronunciations or update allowable pronunciations based on an incorrect prediction. The incorporation of the incorrect prediction in updating the pronunciation model can create more precise and accurate delineations between possible pronunciations and incorrect pronunciations. In addition, the device can maintain the incorrect prediction as a separate but similar text entity with associated pronunciations rather than overwriting the incorrect prediction for all future instances. As an example, a first contact and a second contact can be saved in a device's digital address book. The first contact and the second contact can have similar spellings and possible pronunciations. In one embodiment, the device can receive a speech request to call the first contact. The device can incorrectly predict that the speech request is a request to call the second contact. The device can then receive a correction input indicating that the speech request included the name of the first contact rather than the name of the second contact. It is beneficial in this situation that the device does not remove the second contact or exclude the name of the second contact in future instances of ASR. Later speech requests may include the name of the second contact rather than the name of the first contact. The device may still need to recognize the second contact in the later speech requests and distinguish between the pronunciation of the first contact's name and the pronunciation of the second contact's name. The use of a pronunciation model for each contact's name can avoid automatic substitutions or overwriting that prevents the device from recognizing one or both contacts in later speech requests, even when the contact's names are similar.

The pronunciation models present an advantage for ASR in that the models can be used to recognize pronunciations in new or unfamiliar contexts. The use of the pronunciation models enables a device to accurately recognize speech even in previously unobserved word contexts. The device can update one or more pronunciation models based on each received audio sample or speech interaction with a user, as has been described herein. The pronunciation models can be generated based on phonetic dictionaries and are not limited to certain use cases or contexts. The predicted and possible pronunciations in each pronunciation model can be available for ASR matching for any audio sample. For example, a device can use a pronunciation model for a contact's name to recognize the name in an audio sample even when the audio sample does not mention device contacts or includes a reference to a different person with the same name. The performance of the device in ASR using the pronunciation model is not negatively affected by unfamiliar contexts or word histories for a text entity. In one embodiment, the incorporation of correction input and incorrect predictions in updating a pronunciation model prevents significant regression of speech recognition that may occur when an incorrect prediction is simply overwritten, removed, or substituted by a correct text.

The systems and methods presented herein are compatible with anonymization and abstraction of data to preserve user privacy and protect user data. For example, a device (e.g., a user device) can store audio samples locally and/or can obscure data related to an audio sample before transmitting the audio sample to a networked device. In one embodiment, a device can store and use intermediate forms of audio data rather than raw waveforms. The intermediate forms can be transformations or encodings of raw audio samples, such as acoustic activations or probability distributions of acoustic frames. The intermediate forms can be used and processed by a neural model for ASR but does not contain sensitive or personal information that can be extracted. In addition, the updating of a pronunciation model in a background thread can enable a device to extract data, such as a phoneme space for a text entity, that is anonymized and does not include personal identifiers related to a user of the device. The device can then transmit the anonymized data to a networked device and/or use the anonymized data for later ASR without exposing the user's personal data or speech in future processing.

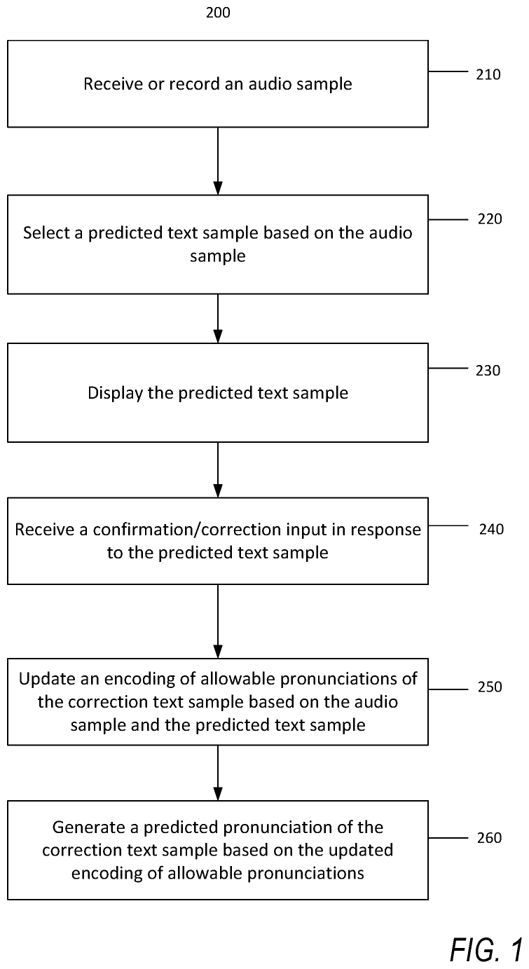

FIG. 1 is a flow chart illustrating a method 200 for predicting a pronunciation of a text sample, according to one embodiment of the present disclosure. The method can be performed by an electronic device such as a mobile phone, a computer, an assistant device, or a server. In step 210, the device can receive an audio sample. The audio sample can be recorded by a microphone, the microphone being embedded in or connected to the device. The audio sample can include a speech request, such as a command or a question, made by a user. The speech request can be presented in natural language. The device can process the audio sample using one or more speech recognition models or methods. In step 220, the device can select a predicted text sample corresponding to the speech request. The predicted text sample can be, for example, a transcription of any portion of the speech request. The predicted text sample can be any unit of text, including, but not limited to, a grapheme, a word, a name, or a phrase. The device can predict the text sample by segmenting the audio sample and matching segments of the audio sample to allowable pronunciations of text samples. The allowable pronunciations of the text samples can be generated based on a pronunciation model for each text sample, the pronunciation model including a phoneme space of allowable pronunciations for the text sample. In one example, the predicted pronunciations can be generated by a G2P model.

In step 230, the device can output the predicted text sample. The outputting can include, for example, displaying the predicted text sample in a displayed prompt. In one embodiment, the output can be an audio output. For example, the device can output the predicted text sample using a text-to-speech (TTS) synthesizer. The device can output the predicted text sample to confirm that the predicted text sample is an accurate text representation of the audio sample received in step 210. Additionally or alternatively, the device can perform an action based on the predicted text sample. In step 240, the device can receive a confirmation or a correction input in response to the predicted text sample. For example, the device can receive a confirmation input indicating that the predicted text sample is an accurate text representation of the audio sample. When the predicted text sample is incorrect, the device can receive a correction input indicating the actual (correct) text representation of the audio sample. For example, the device can receive a correction text sample via a UI of the device.

In step 250, the device can update an encoding of allowable pronunciations of the correction text sample received in step 240. In one embodiment, the device can include the pronunciation in the audio sample received in step 210 in the encoded phoneme space of allowable pronunciations for the correction text sample. In one embodiment, the device can include a pronunciation of the predicted text sample in the phoneme space of allowable pronunciations for the correction text sample. For example, the pronunciation of the predicted text sample can be a reference pronunciation for the correction text sample. In one embodiment, the device can update the encoded phoneme space of allowable pronunciations based on the pronunciation of the predicted text sample. For example, the device can remove pronunciations that are similar to the pronunciation of the predicted text sample from the phoneme space. Alternatively or additionally, the device can modify predicted accuracies or rankings of pronunciations in the phoneme space based on the predicted text sample. For example, the device can determine that a pronunciation that is similar to the pronunciation of the predicted text sample is less likely to be an acceptable pronunciation of the correction text sample. Thus, the device will be less likely to use the correction text sample as a prediction for that pronunciation.

In step 260, the device can generate new predicted pronunciations for the correction text sample based on the updated pronunciation model. For example, the device can generate pronunciations that are similar to the pronunciation in the audio sample received in step 210. In one embodiment, the device can generate pronunciations based on the reference pronunciation of the incorrect, predicted text sample. For example, the device can generate pronunciations that differ from the reference pronunciation in at least one phoneme or syllable.

In an embodiment wherein the input received in step 240 is a confirmation input, the device can update the pronunciation model for the predicted text sample. For example, the confirmation input can indicate that the predicted text sample is an accurate text representation of the audio sample. The device can update the pronunciation model for the predicted text sample so that the pronunciation in the audio sample is included in the phoneme space as a correct pronunciation of the predicted text sample. In one embodiment, the device can determine that pronunciations similar to the pronunciation in the audio sample are also allowable or likely pronunciations of the predicted text sample. In one embodiment, the device can use a predictive model, such as a G2P model, to generate pronunciations of the predicted text sample based on the pronunciation in the audio sample.

In one embodiment, the device can update more than one pronunciation model based on the confirmation or correction input received in step 240. For example, when the device receives a correction input indicating a correction text sample, the device can update the pronunciation model for the correction text sample as well as the pronunciation model for the predicted text sample based on the audio sample. The device can update the pronunciation model for the predicted text sample to decrease the probability of a match between a pronunciation in the audio sample and a pronunciation of the predicted text sample. In one example, when the device receives a confirmation input indicating that the predicted text sample is correct, the device can update pronunciation models for one or more alternative text samples. The alternative text samples can include text samples used for reference pronunciations in the pronunciation model of the predicted (correct) text sample. The device can improve the accuracy of pronunciation prediction for a number of text entities based on the single audio sample and confirmation/correction input received.

It can be appreciated that the method of FIG. 1 and the pronunciation models as presented herein can be integrated into other ASR models and speech processing functions. For example, the device can further encode and/or decode the audio sample. In one embodiment, the method of FIG. 1 can be distributed among more than one device. For example, a first device can be a mobile device configured to record an audio sample with a microphone and transmit the recorded audio sample to a second device over a communication network. The second device can be a server configured for ASR and can store or access pronunciation models associated with the first device. The second device can select a predicted text sample based on the received audio sample and can transmit the predicted text sample to the first device over the communication network. The first device can display the predicted text sample and receive the confirmation/correction input. The first device can then transmit the confirmation/correction input to the second device. The second device can update the corresponding pronunciation model or models based on the confirmation/correction input.

In the following example, a device configured with a voice-activated assistant can use the methods presented herein to determine pronunciations of a foreign contact name. The device can be, for example, a mobile phone. The mobile phone can include a contact named “Mathijn” stored in a digital address book. The voice-activated assistant of the mobile phone can be activated by a speech request by a user to “call Mathijn.” The mobile phone can process and transcribe the speech request using ASR and can predict that the request was to “call Martin” because the two names have similar pronunciations. The mobile phone may predict the name Martin because the digital address book contains a contact named Martin. In one embodiment, the mobile phone can predict the name in the speech request using a pronunciation model. The pronunciation model for the name Martin can include a pronunciation similar to the pronunciation in the speech request of the user. The name in the speech request can thus be matched to a pronunciation in the Martin pronunciation model. The mobile phone can display a confirmation prompt, wherein the confirmation prompt can include Martin as the contact's name that was identified in the speech request. The mobile phone can receive a correction input. For example, the mobile phone can receive a text input, wherein the text input can include the name Mathijn. The mobile phone can process the correction text input to identify that the speech request included the name Mathijn rather than Martin.

The mobile phone can update an encoding of allowable pronunciations for Mathijn based on the correction text input. First, the mobile phone can identify that Martin and Mathijn can have similar pronunciations because Martin was predicted as an incorrect transcription of the name Mathijn. In one embodiment, the mobile phone can add Martin as a reference point for Mathijn to a phoneme space of pronunciations for Mathijn. The device can determine that a pronunciation of Mathijn can be similar to, but distinct from, a pronunciation of Martin. The mobile phone can also identify that the speech request contains a possible pronunciation of Mathijn. In one embodiment, the mobile phone can add the pronunciation in the speech request to the phoneme space for Mathijn. In one embodiment, the mobile phone can generate one or more predicted pronunciations for Mathijn based on the updates to the pronunciation model. For example, the mobile phone can use a sequence-to-sequence G2P model to generate a predicted pronunciation. In one embodiment, the G2P model can generate the predicted pronunciation based on the phoneme space of Mathijn. For example, the G2P model can use the pronunciation of Martin to generate a pronunciation of Mathijn that is distinct from the pronunciation of Martin.

In a subsequent embodiment, the voice-activated assistant can be activated by a speech request by a user to provide “directions to Mathijn.” The mobile phone can process and transcribe the speech request using ASR and can predict that the request was to provide “directions to Mautenne” because the two proper nouns have similar pronunciations. The mobile phone may predict the word Mautenne because it is a name of a location to which directions can be generated. In one embodiment, the mobile phone can predict the transcription of the speech request by matching the speech request to a pronunciation in a pronunciation model of the word Mautenne. The mobile phone can generate and display directions to a location based on the word Mautenne. The mobile phone can receive a text input including the name Mathijn as a correction input. The mobile phone can process the correction text input to identify that the speech request included the name Mathijn rather than Mautenne.

The mobile phone can then update the encoding of pronunciations for Mathijn based on the correction text input. First, the mobile phone can identify that Mathijn and Mautenne have similar pronunciations because Mautenne was predicted as an incorrect transcription of the name Mathijn. In one embodiment, the mobile phone can add Mautenne as a reference point for Mathijn to a phoneme space of pronunciations for Mautenne. The device can determine that a pronunciation of Mathijn can be similar to, but distinct from, a pronunciation of Mautenne. The pronunciation of Mautenne included in the phoneme space can be a predicted pronunciation generated by the device using a G2P model. The mobile phone can also identify that the speech request contains a possible pronunciation of Mathijn. In one embodiment, the mobile phone can add the pronunciation of the speech request to the phoneme space for Mathijn. In one embodiment, the mobile phone can generate one or more predicted pronunciations for Mathijn based on the updates to the pronunciation model. For example, the mobile phone can use a sequence-to-sequence G2P model to generate a predicted pronunciation of Mathijn. In one embodiment, the G2P model can generate the predicted pronunciation of Mathijn based on the updated phoneme space for Mathijn. For example, the G2P model can use the pronunciation of Mautenne in addition to the pronunciation of Martin to generate a pronunciation of Mathijn that is distinct from the pronunciation of both Mautenne and Martin. In one embodiment, the mobile phone can identify that Mathijn is a Dutch name using natural language processing techniques. The mobile phone can use the G2P model to generate pronunciations using Dutch phonetics.

Martin and Mautenne can both be used as reference points in the pronunciation model for Mathijn. However, each reference point can differ in phonetic proximity or similarity to an allowable pronunciation of Mathijn, such as the pronunciation provided in the speech requests that were processed by the mobile phone. In one embodiment, the mobile phone can compute an acoustic score for each reference point, wherein the acoustic score is based on a proximity to an allowable pronunciation of Mathijn. In one embodiment, the acoustic score can be calculated based on a phonetic dictionary or phonetic rules. For example, Mautenne may be a closer phonetic fit for Mathijn than Martin. The mobile phone can use the acoustic scores to generate predicted pronunciations of Mathijn. For example, predicted pronunciations can be closer to Mautenne than to Martin in one or more phonemes.

The mobile phone can continue to update and use the pronunciation model for Mathijn to process future audio samples. The processing can include predicting Mathijn as a text representation matching an audio sample based on the pronunciation model for Mathijn. Notably, the pronunciation model can include pronunciations of Mathijn that are agnostic of surrounding words or context. Therefore, the mobile phone can predict Mathijn as a text match for any audio sample and is not limited to previously encountered speech requests, such as “call” or “direction” requests. The mobile phone can also continue to predict Martin and Mautenne as text matches for audio samples when appropriate, e.g., when the audio samples match the respective pronunciation models for Martin and Mautenne.

The above contact and location names are presented herein for illustrative purposes. It can be appreciated that a text entity can include names or words that are not standard or recognized in any language. For example, a device can generate a pronunciation model for a text entity that has been made up by a user of the device and does not have a known definition. In one embodiment, the text entity can include numbers, symbols, emoticons, Unicode encodings, etc. in combination with letters. A device can generate and update pronunciation models for a number of text entities so that each text entity can remain a viable candidate for speech recognition. In this manner, text entities that are similar to each other will not be overwritten or removed from a library of possible text entities for speech recognition. The phoneme space for each text entity can be well-defined and updated based on correction inputs to improve the accuracy of predicted pronunciations and future speech recognition. The methods presented herein for generating and updating pronunciation models and for predicting a pronunciation can be used independently and in combination. For example, a device can generate a pronunciation model for a text entity based on a correction input and can predict a most likely pronunciation for the text entity based on a posterior distribution of pronunciations for the text entity. The device can take steps from one or more methods in combination to improve accuracy of predictions.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the networked device or server 1500 and 1501, the devices 1100, 1101, 110n, and the like. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 2 can be an example of one or more of the devices described herein, including an electronic device configured to predict pronunciation of a text entity and a client device configured to record or receive an audio sample. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The exemplary user device 20 of FIG. 2 includes processing circuitry, as discussed above. The processing circuitry includes one or more of the elements discussed next with reference to FIG. 2. The electronic user device 20 may include other components not explicitly illustrated in FIG. 2 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect fingers on the left side of the user device 20 (e.g., on an edge of the display 420 or on the protective casing), and detect a single finger on the right side of the user device 20. In this exemplary scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

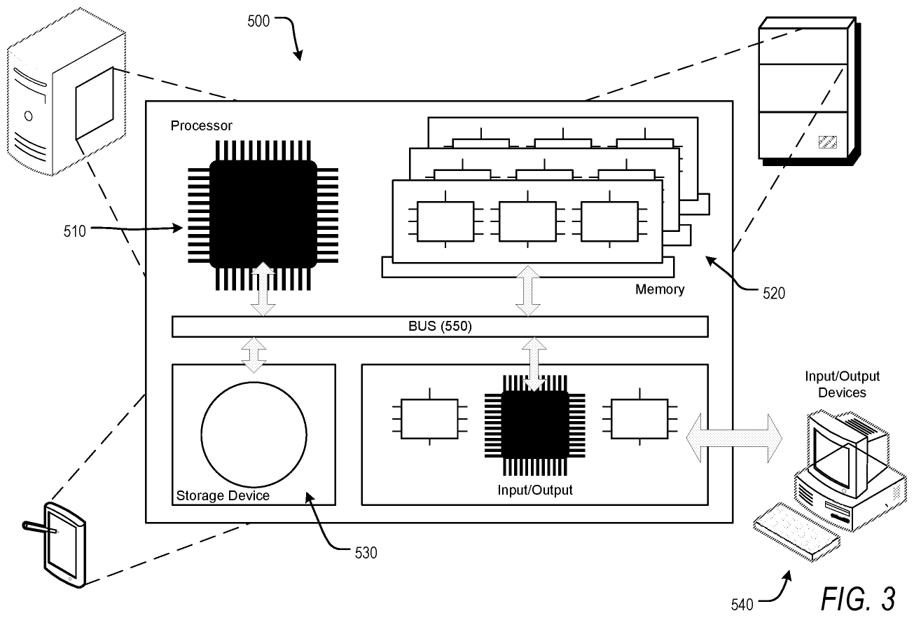

An example of a type of computer is shown in FIG. 3. The computer 500 can be used for the operations described in association with any of the computer-implement methods described previously, according to one implementation. For example, the computer 500 can be an example of an electronic device, such as a computer or mobile device, or a networked device such as a server. The processing circuitry includes one or more of the elements discussed next with reference to FIG. 3. In FIG. 3, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

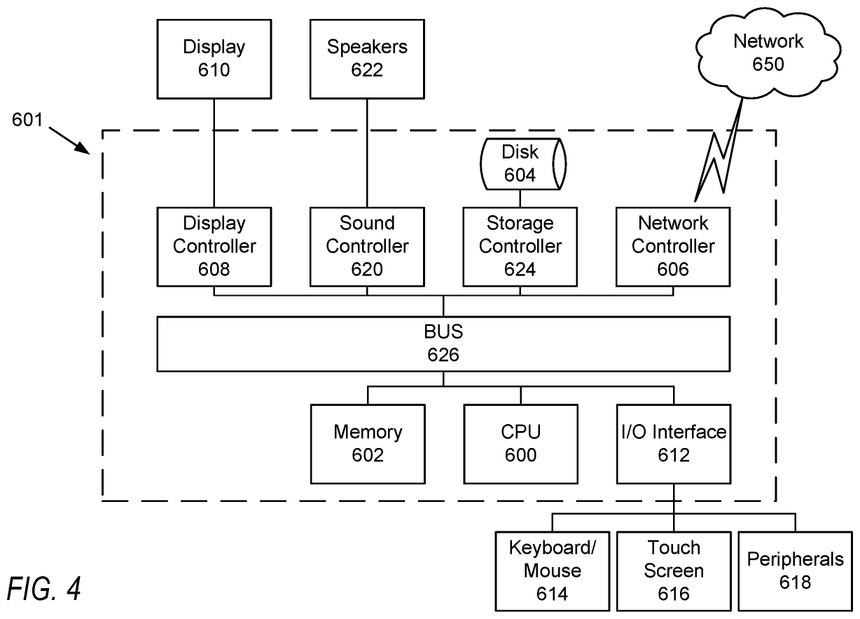

Next, a hardware description of a device 601 according to exemplary embodiments is described with reference to FIG. 4. In FIG. 4, the device 601, which can be any of the above described devices, including the electronic devices and the networked devices, includes processing circuitry. The processing circuitry includes one or more of the elements discussed next with reference to FIG. 4. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 4 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA Geforce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.

(1) A method for predicting pronunciation of a text sample, comprising selecting, via processing circuitry, a predicted text sample corresponding to an audio sample; receiving, via the processing circuitry, a correction text sample corresponding to the audio sample; updating, via the processing circuitry, an encoding of allowable pronunciations of the correction text sample based on the predicted text sample and the audio sample, the updated encoding of allowable pronunciations of the correction text sample including a pronunciation of the predicted text sample; and predicting, via the processing circuitry, a pronunciation of the correction text sample based on the updated encoding of allowable pronunciations of the correction text sample.

(2) The method of (1), wherein the predicted text sample is selected based on an encoding of allowable pronunciations of the predicted text sample.

(3) The method of (1) to (2), further comprising selecting an alternative text sample corresponding to the audio sample based on an encoding of allowable pronunciations for the alternative text sample, the alternative text sample including the correction text sample and the correction text sample being based on the alternative text sample.

(4) The method of (1) to (3), wherein the updated encoding of allowable pronunciations of the correction text sample is based on an acoustic similarity between an allowable pronunciation and the pronunciation of the predicted text sample.

(5) The method of (1) to (4), wherein the predicted pronunciation of the correction text sample is predicted by a grapheme to phoneme model.

(6) The method of (1) to (5), wherein the predicted pronunciation of the correction text sample is predicted based on the pronunciation of the predicted text sample.

(7) A device comprising: processing circuitry configured to select a predicted text sample corresponding to an audio sample, receive a correction text sample corresponding to the audio sample and based on the predicted text sample, update an encoding of allowable pronunciations of the correction text sample based on the predicted text sample and the audio sample, the updated encoding of allowable pronunciations of the correction text sample including a pronunciation of the predicted text sample, and predict a pronunciation of the correction text sample based on the updated encoding of allowable pronunciations of the correction text sample.

(8) The device of (7), wherein the processing circuitry is further configured to receive the audio sample from a second device.

(9) The device of (7) to (8), wherein the predicted text sample is selected based on an encoding of allowable pronunciations of the predicted text sample.

(10) The device of (7) to (9), wherein the processing circuitry is further configured to select an alternative text sample corresponding to the audio sample based on an encoding of allowable pronunciations for the alternative text sample, the alternative text sample including the correction text sample, and the correction text sample being based on the alternative text sample.

(11) The device of (7) to (10), wherein the updated encoding of allowable pronunciations of the correction text sample is based on an acoustic similarity between an allowable pronunciation and the pronunciation of the predicted text sample.

(12) The device of (7) to (11), wherein the predicted pronunciation of the correction text sample is predicted by a grapheme to phoneme model.

(13) The device of (7) to (12), wherein the predicted pronunciation of the correction text sample is predicted based on the pronunciation of the predicted text sample.

(14) A non-transitory computer-readable storage medium for storing computer-readable instructions that, when executed by a computer, cause the computer to perform a method, the method comprising: selecting a predicted text sample corresponding to an audio sample, receiving a correction text sample corresponding to the audio sample and based on the predicted text sample, updating an encoding of allowable pronunciations of the correction text sample based on the predicted text sample and the audio sample, the updated encoding of allowable pronunciations of the correction text sample including a pronunciation of the predicted text sample, and predicting a pronunciation of the correction text sample based on the updated encoding of allowable pronunciations of the correction text sample.

(15) The non-transitory computer-readable storage medium of (14), wherein the method further includes receiving the audio sample from a second device.

(16) The non-transitory computer-readable storage medium of (14) to (15), wherein the predicted text sample is selected based on an encoding of allowable pronunciations of the predicted text sample.

(17) The non-transitory computer-readable storage medium of (14) to (16), the method further comprising selecting an alternative text sample corresponding to the audio sample based on an encoding of allowable pronunciations for the alternative text sample, the alternative text sample including the correction text sample and wherein the correction text sample being based on the alternative text sample.

(18) The non-transitory computer-readable storage medium of (14) to (17), wherein the updated encoding of allowable pronunciations of the correction text sample is based on an acoustic similarity between an allowable pronunciation and the pronunciation of the predicted text sample.

(19) The non-transitory computer-readable storage medium of (14) to (18), wherein the predicted pronunciation of the correction text sample is predicted by a grapheme to phoneme model.

(20) The non-transitory computer-readable storage medium of (14) to (19), wherein the predicted pronunciation of the correction text sample is predicted based on the pronunciation of the predicted text sample.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method for predicting pronunciation of a text sample, comprising:
selecting, via processing circuitry, a predicted text sample corresponding to an audio sample;
receiving, via the processing circuitry, a correction text sample corresponding to the audio sample;
updating, via the processing circuitry, an encoding of allowable pronunciations of the correction text sample based on the predicted text sample and the audio sample, the updated encoding of allowable pronunciations of the correction text sample including a pronunciation of the predicted text sample; and
predicting, via the processing circuitry, a pronunciation of the correction text sample based on the updated encoding of allowable pronunciations of the correction text sample.

2. The method of claim 1, wherein the predicted text sample is selected based on an encoding of allowable pronunciations of the predicted text sample.

3. The method of claim 1, further comprising selecting an alternative text sample corresponding to the audio sample based on an encoding of allowable pronunciations for the alternative text sample, the alternative text sample including the correction text sample, and the correction text sample being based on the alternative text sample.

4. The method of claim 1, wherein the updated encoding of allowable pronunciations of the correction text sample is based on an acoustic similarity between an allowable pronunciation and the pronunciation of the predicted text sample.

5. The method of claim 1, wherein the predicted pronunciation of the correction text sample is predicted by a grapheme to phoneme model.

6. The method of claim 1, wherein the predicted pronunciation of the correction text sample is predicted based on the pronunciation of the predicted text sample.

7. A device comprising:
processing circuitry configured to
select a predicted text sample corresponding to an audio sample,
receive a correction text sample corresponding to the audio sample and based on the predicted text sample,
update an encoding of allowable pronunciations of the correction text sample based on the predicted text sample and the audio sample, the updated encoding of allowable pronunciations of the correction text sample including a pronunciation of the predicted text sample, and
predict a pronunciation of the correction text sample based on the updated encoding of allowable pronunciations of the correction text sample.

8. The device of claim 7, wherein the processing circuitry is further configured to receive the audio sample from a second device.

9. The device of claim 7, wherein the predicted text sample is selected based on an encoding of allowable pronunciations of the predicted text sample.

10. The device of claim 7, wherein the processing circuitry is further configured to select an alternative text sample corresponding to the audio sample based on an encoding of allowable pronunciations for the alternative text sample, the alternative text sample including the correction text sample, and the correction text sample being based on the alternative text sample.

11. The device of claim 7, wherein the updated encoding of allowable pronunciations of the correction text sample is based on an acoustic similarity between an allowable pronunciation and the pronunciation of the predicted text sample.

12. The device of claim 7, wherein the predicted pronunciation of the correction text sample is predicted by a grapheme to phoneme model.

13. The device of claim 7, wherein the predicted pronunciation of the correction text sample is predicted based on the pronunciation of the predicted text sample.

14. A non-transitory computer-readable storage medium for storing computer-readable instructions that, when executed by a computer, cause the computer to perform a method, the method comprising:
selecting a predicted text sample corresponding to an audio sample;
receiving a correction text sample corresponding to the audio sample and based on the predicted text sample;
updating an encoding of allowable pronunciations of the correction text sample based on the predicted text sample and the audio sample, the updated encoding of allowable pronunciations of the correction text sample including a pronunciation of the predicted text sample; and
predicting a pronunciation of the correction text sample based on the updated encoding of allowable pronunciations of the correction text sample.

15. The non-transitory computer-readable storage medium of claim 14, wherein the method further includes receiving the audio sample from a device.

16. The non-transitory computer-readable storage medium of claim 14, wherein the predicted text sample is selected based on an encoding of allowable pronunciations of the predicted text sample.

17. The non-transitory computer-readable storage medium of claim 14, the method further comprising selecting an alternative text sample corresponding to the audio sample based on an encoding of allowable pronunciations for the alternative text sample, the alternative text sample including the correction text sample and the correction text sample being based on the alternative text sample.

18. The non-transitory computer-readable storage medium of claim 14, wherein the updated encoding of allowable pronunciations of the correction text sample is based on an acoustic similarity between an allowable pronunciation and the pronunciation of the predicted text sample.

19. The non-transitory computer-readable storage medium of claim 14, wherein the predicted pronunciation of the correction text sample is predicted by a grapheme to phoneme model.

20. The non-transitory computer-readable storage medium of claim 14, wherein the predicted pronunciation of the correction text sample is predicted based on the pronunciation of the predicted text sample.
